(19) United States
(12) Patent Application Publication
(10) Pub. No.: US 2024/0331919 A1
(43) Pub. Date: Oct. 3, 2024

(54) COIL DEVICE

(71) Applicant: TDK CORPORATION, Tokyo (JP)

(72) Inventors: Hirofumi SASAKI, Tokyo (JP); Koji SHIMURA, Tokyo (JP); Kyosuke INUI, Tokyo (JP)

(73) Assignee: TDK CORPORATION, Tokyo (JP)

(21) Appl. No.: 18/616,735

(22) Filed: Mar. 26, 2024

(30) Foreign Application Priority Data
Mar. 30, 2023 (JP) 2023-056585

(51) Int. Cl. H01F 27/255; H01F 27/28

(52) U.S. Cl. CPC H01F 27/255; H01F 27/2823

(57) ABSTRACT

A coil device comprises a first magnetic material portion containing a magnetic material and having a plate-shaped portion and a protrusion protruding, a metal wire having a winding portion including two or more layers of winding layers, and a second magnetic material portion containing a magnetic material and a resin, having a content ratio of the magnetic material smaller than that of the first magnetic material portion, and covering at least an outer peripheral side of the winding portion, wherein inter-wire spaces defined by circumscribed circles circumscribing three different wire cross sections and having a diameter smaller than a radius of each wire cross section are formed, and first inter-wire spaces not including a magnetic material and second inter-wire spaces including a magnetic material are included in the inter-wire spaces.

### BACKGROUND OF THE INVENTION

### 1. Technical Field

The present invention relates to a coil device used as an inductor element or the like.

### 2. Description of the Related Art

As a coil device, a combination of two types of core portions having different content ratios of resin and magnetic material and a winding portion has been proposed. In such a coil device, by using two types of core portions having different content ratios of resin and magnetic material, it is possible to relax stress and prevent occurrence of cracks.

In such a coil device, a form in which a space of each wire cross section in the winding portion is filled with a magnetic material has been proposed, and such a coil device is advantageous from the viewpoint of improving inductance. However, in such a coil device, there is a problem that dielectric breakdown between wire cross sections occurs in a compression molding process or the like in which the space of the winding portion is filled with the magnetic material. Meanwhile, in the coil device in which the space of the winding portion is not filled with the magnetic material, the insulation between the wires is maintained, but the magnetic material does not exist in the space of the winding portion, and thus there is a problem from the viewpoint of improving the inductance.

### CITATION LIST

### Patent Literature

Patent Literature 1: JP 2017-199734 A

### BRIEF SUMMARY OF THE INVENTION

The present disclosure has been made in view of such circumstances, and provides a coil device capable of preventing dielectric breakdown of a metal wire and improving inductance.

According to an aspect of the present disclosure, there is provided a coil device comprising:
a first magnetic material portion containing a magnetic material and having a plate-shaped portion and a protrusion protruding from the plate-shaped portion;
a metal wire having a winding portion including two or more layers of winding layers wound around the protrusion; and
a second magnetic material portion containing a magnetic material and a resin, having a content ratio of the magnetic material smaller than that of the first magnetic material portion, and covering at least an outer peripheral side of the winding portion,
wherein, viewed in a predetermined cross section including a winding axis of the winding portion, in which wire cross sections of the metal wire are observed, inter-wire spaces defined by circumscribed circles circumscribing three different wire cross sections in the winding portion and having a diameter smaller than a radius of each wire cross section are formed, and
first inter-wire spaces not including a magnetic material and second inter-wire spaces including a magnetic material are included in the inter-wire spaces.

In the coil device according to the present disclosure, inter-wire spaces formed in the winding portion are formed, and the first inter-wire space not including a magnetic material and the second inter-wire space including a magnetic material are included in the inter-wire spaces. In such a coil device, the second inter-wire space improves the inductor, and the presence of the first inter-wire space can prevent a problem that dielectric breakdown occurs between wire cross sections.

Further, for example, at least one of the second inter-wire spaces is an outer second inter-wire space in which at least two of the three circumscribed wire cross sections are directed to the second magnetic material portion.

Since the outer second inter-wire space includes the magnetic material, the inductor is improved, and the space is close to the second magnetic material portion. Therefore, even when the outer second inter-wire space is formed, dielectric breakdown between the wire cross sections hardly occurs.

In the outer second inter-wire space, at least one of the wire cross sections circumscribing the outer second inter-wire space and directed to the second magnetic material portion is further away from the plate-shaped portion as compared with the outer second inter-wire spaces.

Since such an outer second inter-wire space is separated from the plate-shaped portion of the first magnetic material portion, occurrence of dielectric breakdown between wire cross sections can be suitably prevented as compared with a case where the second inter-wire space is formed near the first magnetic material portion.

Further, for example, at least one of the first inter-wire spaces is an inner first inter-wire space in which at least two of the three circumscribed wire cross sections are directed to the first magnetic material portion.

In such a coil device, since the first inter-wire space not including the magnetic material is disposed near the first magnetic material portion, occurrence of dielectric breakdown between wire cross sections can be suitably prevented.

Further, for example, the metal wire is a round wire having a substantially circular or substantially elliptical in a cross section.

Since the metal wire is a round wire, it is possible to form the second inter-wire space with low compressive stress, which contributes to improvement of inductance and prevents occurrence of dielectric breakdown between wire cross sections.

Further, for example, a plate-shaped portion inter-wire space defined by a circumscribed circle circumscribing two different wire cross sections of the winding portion and the plate-shaped portion, and having a diameter smaller than a radius of each of the wire cross sections, and not including a magnetic material is formed in the predetermined cross section.

In the coil device having such a plate-shaped portion inter-wire space, the occurrence of dielectric breakdown between the wire cross sections can be prevented by making a space near the wire cross sections susceptible to relatively strong deformation stress among the wire cross sections included in the winding portion a pore.

Further, for example, a mean particle diameter of the magnetic material included in the second inter-wire spaces is smaller than a mean particle diameter of the magnetic material included in the second magnetic material portion.

In such a coil device, since the amount of the magnetic material included in the second inter-wire spaces can be increased with a lower compressive force, it is possible to contribute to improvement of inductance and prevent occurrence of dielectric breakdown between wire cross sections.

Further, for example, an average distance from a corner portion formed between the plate-shaped portion and the protrusion to the second inter-wire spaces included in the predetermined cross section is longer than an average distance from the corner portion to the first inter-wire spaces included in the predetermined cross section.

Such a coil device can improve inductance while preventing occurrence of dielectric breakdown between wire cross sections by forming the second inter-wire space including the magnetic material in a region that tends to receive relatively weak deformation stress in the wire cross sections included in the winding portion.

In addition, for example, the content ratio of the magnetic material in the second magnetic material portion is 50% or more.

Such a coil device can increase the value of the permeability of the second magnetic material portion, and can improve the inductance. Further, in the coil device, since the first inter-wire space is formed in the winding portion, even when the molding pressure of the second magnetic material portion is increased to increase the content ratio of the magnetic material, occurrence of dielectric breakdown between the wire cross sections can be suitably prevented.

### BRIEF DESCRIPTION OF THE DRAWINGS

FIG. 1 is a partially transparent perspective view of a coil device according to one embodiment of the present disclosure;

FIG. 2 is a cross-sectional view of the coil device illustrated in FIG. 1;

FIG. 3 is an enlarged cross-sectional view in which the periphery of a winding portion in a cross section illustrated in FIG. 2 is enlarged; and

FIG. 4 is a conceptual diagram illustrating an inter-wire space included in the cross section illustrated in FIG. 3.

### DETAILED DESCRIPTION OF THE INVENTION

### First Embodiment

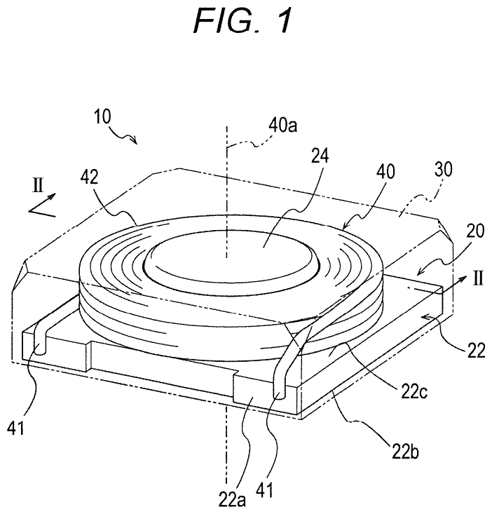

FIG. 1 is a partially transparent perspective view of a coil device 10 according to one embodiment of the present disclosure. As illustrated in FIG. 1, the coil device 10 includes a first magnetic material portion 20, a second magnetic material portion 30, and a metal wire 40. In addition, the coil device 10 includes a pair of terminal electrodes (not illustrated in FIG. 1) connected to the metal wire 40. In FIG. 1, in order to understand an internal structure of the coil device 10, the second magnetic material portion 30 is displayed as a virtual line in a see-through manner.

As illustrated in FIG. 1, the coil device 10 has a substantially rectangular parallelepiped outer shape, and the first magnetic material portion 20 is disposed near a bottom surface of the coil device 10. The first magnetic material portion 20 contains a magnetic material, and includes a plate-shaped portion 22 having a substantially rectangular tabular shape and a columnar protrusion 24 protruding upward from a central portion of the plate-shaped portion 22.

The first magnetic material portion 20 includes, for example, a sintered core made of a magnetic material not containing a resin, a core containing a resin and a magnetic material formed by compression molding or injection molding granules containing a magnetic material powder constituting the magnetic material and a resin as a binder, and the like. The magnetic material powder is not particularly limited, and for example, metal magnetic material powder such as Sendust (Fe—Si—Al; iron-silicon-aluminum), Fe—Si—Cr (iron-silicon-chromium), permalloy (Fe—Ni), carbonyl iron-based, carbonyl Ni-based, amorphous powder, and nanocrystal powder may be preferably used.

However, the magnetic material powder may be a ferrite magnetic material powder such as Mn—Zn or Ni—Cu—Zn. When the first magnetic material portion 20 contains a magnetic material and a resin, a binder resin contained in the first magnetic material portion 20 is not particularly limited, and examples thereof include an epoxy resin, a phenol resin, an acrylic resin, a polyester resin, polyimide, polyamideimide, a silicon resin, and a combination thereof.

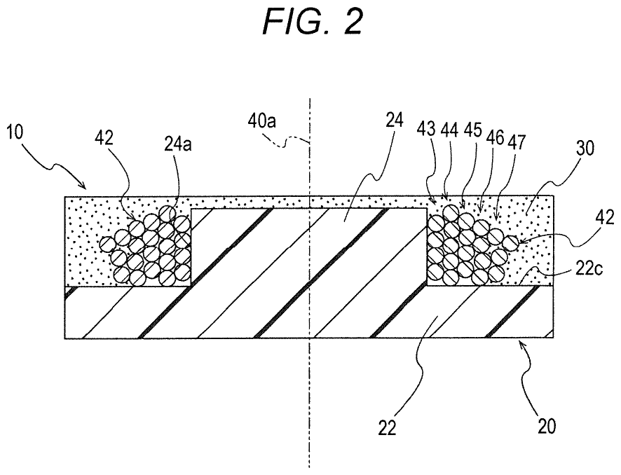

As illustrated in FIG. 2 which is a cross-sectional view, the first magnetic material portion 20 functions as a core in the coil device 10 together with the second magnetic material portion 30 to be described later. The plate-shaped portion 22 has a larger projected area than the protrusion 24 when viewed from above. A thickness of the plate-shaped portion 22 can be set to about 10 to 40% of the total thickness of the coil device 10, but is not particularly limited. The shape of the plate-shaped portion 22 is not limited only to the substantially rectangular tabular shape, and may be a shape other than the rectangular tabular shape, such as a polygonal plate shape, a circular plate shape, or an elliptical plate shape.

The protruding height of the protrusion 24 is also not particularly limited, but can be set to about 20 to 60% of the entire thickness of the coil device 10. The outer peripheral shape of the protrusion 24 illustrated in FIG. 1 is not limited to a circular shape, and may be a shape other than a circular shape, such as an elliptical shape or a polygonal shape, but is preferably a circular shape or an elliptical shape from the viewpoint of winding the metal wire 40 in close contact with the outer periphery of the protrusion 24.

As illustrated in FIG. 1, the metal wire 40 includes a winding portion 42 that forms two or more winding layers around the protrusion 24, and a wire end portion 41 drawn out from the winding portion 42. Although not illustrated in FIGS. 1 to 4, an insulating coating layer is formed on the surface of the metal wire 40.

The metal wire 40 is made of, for example, Cu, Al, Fe, Ag, Au, phosphor bronze, or the like. Examples of the material of the insulating coating layer formed on the surface of the metal wire 40 include polyurethane, polyamideimide, polyimide, polyester, polyester-imide, polyester-nylon, and the like.

A part of the metal wire 40 is wound around the protrusion 24 to form the winding portion 42. As illustrated in FIG. 2, which is a cross-sectional view taken along a predetermined cross section including a winding axis 40a of the winding portion 42, the winding portion 42 is disposed in a region defined by a substantially L-shaped wall formed by a plate-shaped portion upper surface 22c of the plate-shaped portion 22 and a protrusion side surface 24a of the protrusion 24. As illustrated in FIG. 2, the winding portion 42 forms two or more winding layers, and in the embodiment, forms the winding layers of the first winding layer 43, the second winding layer 44, the third winding layer 45, the fourth winding layer 46, and the fifth winding layer 47. The first winding layer 43 is pressed against the protrusion side surface 24a of the protrusion 24 and wound, and the second winding layer 44 is pressed against the first winding layer 43 on the inner peripheral side and wound. Similarly to the second winding layer 44, the third winding layer 45, the fourth winding layer 46, and the fifth winding layer 47 are also pressed against the winding layer on the inner peripheral side and wound.

The winding portion 42 is preferably formed by winding the metal wire 40 around the winding portion 42 with a winding machine or the like from the viewpoint of bringing the winding portion 42 into close contact with the protrusion side surface 24a and increasing the winding density. However, the winding portion 42 may be formed of an air-core coil. The number of winding layers included in the winding portion 42 is also not particularly limited, and any two or more winding layers can be formed around the winding portion 42.

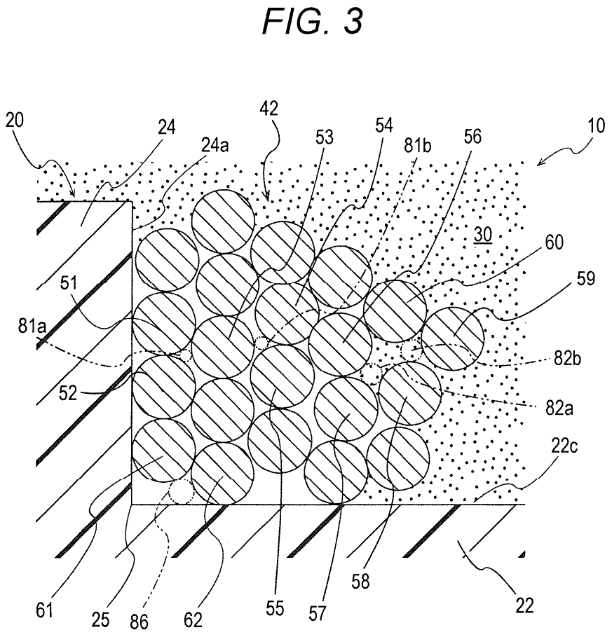

As illustrated in FIG. 2, the metal wire 40 is a round wire whose wire cross section (see the wire cross section 51 to 62 illustrated in FIG. 3 and the like) is substantially circular or substantially elliptical, and an inter-wire space (see first inter-wire spaces 81a and 81b and second inter-wire spaces 82a and 82b illustrated in FIG. 3.) is formed in a predetermined cross section including the winding axis 40a. The metal wire 40 is preferably a round wire from the viewpoint of introducing a magnetic material into a part of the inter-wire space, but is not limited thereto, and a flat wire or the like can also be used as the metal wire 40.

As illustrated in FIG. 1, the metal wire 40 has a pair of wire end portions 41 drawn out from both ends of the winding portion 42, and each wire end portion 41 is connected to a terminal electrode portion (not illustrated) formed on a plate-shaped portion side surface 22a and a plate-shaped portion bottom surface 22b of the plate-shaped portion 22. The terminal electrode portion may be, for example, a metal terminal such as copper or a copper alloy bonded to the plate-shaped portion 22, a baked electrode containing silver, a silver alloy, or the like, or a metal film electrode formed by plating or the like.

As illustrated in FIG. 2, the second magnetic material portion 30 covers at least the outer peripheral side of the winding portion 42 and constitutes the core of the coil device 10 together with the first magnetic material portion 20. The second magnetic material portion 30 contains a magnetic material and a resin. The second magnetic material portion 30 contains a magnetic material similarly to the first magnetic material portion 20, but a content ratio of the magnetic material is smaller than that of the first magnetic material portion 20. Since the second magnetic material portion 30 has a small content ratio of the magnetic material, the second magnetic material portion 30 can be disposed around the winding portion 42 in a state of having fluidity at the time of manufacturing, whereby the second magnetic material portion 30 can be brought into close contact with the winding portion 42 from the outer peripheral side and the upper side without any space.

As the magnetic material included in the second magnetic material portion 30, metal magnetic material powder or ferrite magnetic material powder similar to those exemplified as the magnetic material powder included in the first magnetic material portion 20 can be used. Examples of the binder resin contained in the second magnetic material portion 30 include an epoxy resin, a phenol resin, an acrylic resin, a polyester resin, polyimide, polyamideimide, a silicon resin, and a combination thereof, as with the first magnetic material portion 20.

When the second magnetic material portion 30 is combined with the first magnetic material portion 20 having only one plate-shaped portion 22 as illustrated in FIGS. 1 and 2, the second magnetic material portion 30 is disposed not only on the outer peripheral side of the winding portion 42 but also on the upper side of the winding portion 42 and the upper side of the protrusion 24. However, when the first magnetic material portion has a drum core shape having a pair of plate-shaped portions sandwiching the protrusion, the second magnetic material portion may be disposed only in a region on the outer peripheral side of the winding portion 42 sandwiched in the vertical direction by the plate-shaped portions.

The second magnetic material portion 30 is manufactured by compression molding or the like. For example, the second magnetic material portion 30 is obtained by putting an intermediate product in which the winding portion 42 is formed by the metal wire 40 around the protrusion 24 of the first magnetic material portion 20 and a mixture of the magnetic material powder and the binder resin to be the material of the second magnetic material portion 30 into a cavity and compressing the whole.

The content ratio of the magnetic material in the second magnetic material portion 30 is preferably 50% or more from the viewpoint of improving inductance, and more preferably 70% or more. In addition, the magnetic material contained in the second magnetic material portion 30 may be composed of two or more types of magnetic material powder having different mean particle diameters. In such a second magnetic material portion 30, since the particle diameter distribution of the magnetic material powder has peaks and is distributed in a wide range, the magnetic material powder having a small particle size easily enters the inter-wire spaces to be described later, and the second inter-wire spaces 82a to 82c to be described later are easily formed with a relatively low compressive force.

FIG. 3 is an enlarged cross-sectional view illustrating a predetermined cross section including the winding axis 40a of the winding portion 42 illustrated in FIG. 2, and a wire cross section 51 to 62 which is a cross section of the metal wire 40 is observed. As illustrated in FIG. 3, in a predetermined cross section including the winding axis 40a, inter-wire spaces defined by circumscribed circles circumscribing three different wire cross sections 51 to 62 in the winding portion 42 and having a diameter smaller than the radius of the wire cross section 51 to 62 are formed. FIG. 3 illustrates first inter-wire spaces 81a and 81b and second inter-wire spaces 82a and 82b among the inter-wire spaces.

For example, the first inter-wire space 81a is defined by a circumscribed circle circumscribing three different wire cross sections 51, 52, 53 and having a diameter smaller than the radius of the wire cross sections 51, 52, 53. Similarly, the first inter-wire space 81b is defined by a circumscribed circle circumscribing three different wire cross sections 53, 54, 55 and having a diameter smaller than the radius of the wire cross sections 53, 54, 55. The first inter-wire spaces 81a and 81b do not include a magnetic material.

For example, the second inter-wire space 82a is defined by a circumscribed circle circumscribing three different wire cross sections 56, 57, and 58 and having a diameter smaller than the radius of the wire cross sections 56, 57, and 58. Similarly, the second inter-wire space 82b is defined by a circumscribed circle circumscribing three different wire cross sections 58, 59, 60 and having a diameter smaller than the radius of the wire cross sections 58, 59, 60. The second inter-wire spaces 82a and 82b include a magnetic material.

As described above, inter-wire spaces 81a, 81b, 82a, and 82b are formed in the cross-section passing through the winding axis 40a of the coil device 10, and the wire spaces include the first inter-wire spaces 81a and 81b not including the magnetic material and the second inter-wire spaces 82a and 82b including the magnetic material. Note that the inter-wire spaces 81a, 81b, 82a, and 82b contain a magnetic material. Whether the magnetic material powder is included or not is determined depending on whether or not the magnetic material powder is observed in the corresponding inter-wire spaces 81a, 81b, 82a, and 82b in the micro-cross-sectional photograph at a magnification of about 250 times.

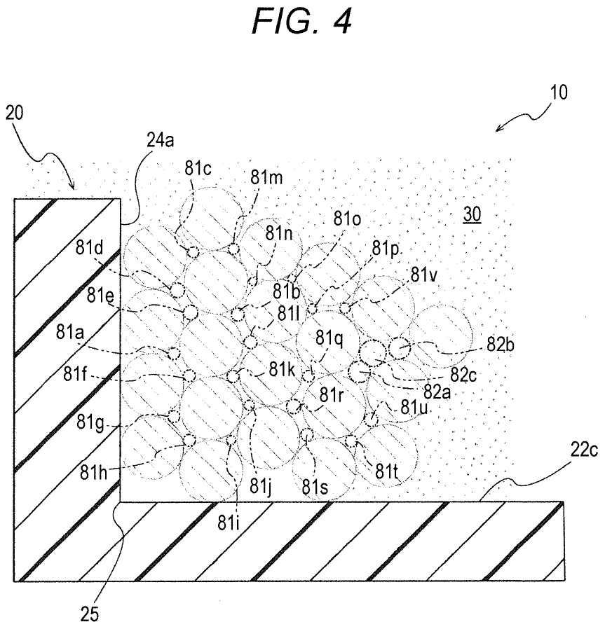

FIG. 4 is a conceptual diagram illustrating all the inter-wire spaces 81a to 81v and 82a to 82c formed in the cross section illustrated in FIG. 3, the circumscribed circle defining each of the inter-wire spaces is indicated by a two-dot chain line, and the wire cross sections 51 to 60 and 61 to 62 and the second magnetic material portion 30 are indicated thinly. As illustrated in FIG. 4, in the coil device 10, a total of 25 inter-wire spaces 81a to 81v and 82a to 82c are formed, and the inter-wire spaces 81a to 81b and 82a to 82c are configured by 22 first inter-wire spaces 81a to 81v and 3 second inter-wire spaces 82a to 82c.

The inter-wire spaces 81a to 81v and 82a to 82c are spaces surrounded between the wire cross sections 51 to 62 in the winding portion 42. The reason why the diameter of the circumscribed circle defining the inter-wire spaces 81a to 81v and 82a to 82c is defined to be smaller than the radius of the wire cross section 51 to 60 is to exclude a large circumscribed circle circumscribing the wire cross section 51 to 60 from the outside of the winding portion 42.

As illustrated in FIG. 3, the second inter-wire spaces 82a and 82b include a magnetic material. The second inter-wire spaces 82a and 82b are formed, for example, by a part of the magnetic material included in the second magnetic material portion 30 flowing into the second inter-wire spaces 82a and 82b from the spaces of the wire cross section 58 to 60 when the second magnetic material portion 30 is compression-molded. The mean particle diameter of the magnetic material included in the second inter-wire spaces 82a and 82b is preferably smaller than the mean particle diameter of the magnetic material included in the second magnetic material portion. By controlling the pressure at the time of compression molding the second magnetic material portion 30 so that the small magnetic material powder selectively flows into the second inter-wire spaces 82a and 82b, it is possible to contribute to the improvement of the inductance of the coil device 10 and to prevent the occurrence of dielectric breakdown between the wire cross sections 51 to 60 and 61 and 62.

Since at least two (all three in the case of the second inter-wire space 82b) of the three circumscribed wire cross sections 58, 59, and 60 are adjacent to the second magnetic material portion 30 without sandwiching the other wire cross sections therebetween, the second inter-wire space 82b is between the outer second inter-wire spaces facing the second magnetic material portion 30. Meanwhile, the second inter-wire space 82a is not the outer second inter-wire space because the wire cross sections 56 and 57, which are two of the three circumscribed wire cross sections 56, 57, and 58, do not face the second magnetic material portion 30.

The second inter-wire space 82b, which is the outer second inter-wire space, is close to the second magnetic material portion 30 and is at a position where the magnetic material easily flows in from the second magnetic material portion 30 at the time of manufacturing. Therefore, the second inter-wire space 82b, which is the outer second inter-wire space, improves the inductance of the coil device 10 by including the magnetic material, and can be formed without applying an excessive force to the wire cross section 58 to 60 included in the winding portion 42. As described above, it is preferable that the coil device 10 has at least one second inter-wire space 82b which is the outer second inter-wire space located outside from the viewpoint of improving inductance and preventing dielectric breakdown in the winding portion 42.

In the second inter-wire space 82b which is the outer second inter-wire space, at least one (wire cross sections 59 and 60 in the second inter-wire space 82b) of the wire cross sections 58 to 60 circumscribing and facing the second magnetic material portion 30 is preferably separated from the plate-shaped portion 22 as compared with the outer second inter-wire space 82b. In the compression molding process of the second magnetic material portion 30, a strong deformation force is likely to act in a region of the winding portion 42 in the vicinity of the first magnetic material portion 20. In particular, in the coil device 10 using the first magnetic material portion 20 having the plate-shaped portion 22 only on the lower side, a strong deformation force tends to act on the winding portion 42 in the vicinity of the plate-shaped portion 22. By forming the outer second inter-wire space 82b in the upper region of the winding portion 42 separated from the plate-shaped portion 22, it is possible to effectively prevent the problem that the insulation film of the metal wire 40 or the like is damaged by the compressive stress acting when the magnetic material flows into the inter-wire space.

Since at least two (wire cross sections 51 and 52 in the case of the first inter-wire space 81a) of the three circumscribed wire cross sections 51, 52, and 53 are adjacent to the first magnetic material portion 20 without sandwiching other wire cross sections therebetween, the first inter-wire space 81a is the inner first inter-wire space facing the first magnetic material portion 20. Meanwhile, since all of the three circumscribed wire cross sections 53, 54, and 55 do not face the first magnetic material portion 20, the first inter-wire space 81b is not the inner first inter-wire space.

The wire cross sections 51 and 52 and the like facing the first magnetic material portion 20 tend to experience relatively strong deformation forces in the compression molding process of the second magnetic material portion 30. In addition, the wire cross sections 51 and 52 and the like facing the first magnetic material portion 20 are far from the second magnetic material portion 30, and inflow of the magnetic material from the second magnetic material portion 30 hardly occurs. Therefore, in the coil device 10 that forms the first inter-wire space 81a which is the inner first inter-wire space, the magnetic material does not flow into a region that tends to be easily damaged, such as an insulating film, and thus, insulation between the wire cross sections 51 and 52 can be suitably ensured.

As illustrated in FIG. 4, in the coil device 10, the average distance from the corner portion 25 formed between the plate-shaped portion 22 and the protrusion 24 to the second inter-wire spaces 82a to 82c included in the predetermined cross section is preferably longer than the average distance from the corner portion 25 to the first inter-wire spaces 81a to 81v included in the predetermined cross section. As a result, it is possible to obtain the coil device 10 having good inductance by allowing the magnetic material to flow from the second magnetic material portion 30 into the second inter-wire spaces 82a to 82c of the winding portion 42 in the inter-wire space with relatively low compressive stress while preventing problems such as damage of the insulating film of the metal wire 40.

As illustrated in FIG. 3, in the coil device 10, in a predetermined cross section including the winding axis 40a, it is also preferable that the plate-shaped portion inter-wire space 86 which is defined by a circumscribed circle circumscribing two different wire cross sections 61 and 62 in the winding portion 42 and the plate-shaped portion upper surface 22c of the plate-shaped portion 22 and has a diameter smaller than the radius of each of the wire cross sections 61 and 62 and does not include a magnetic material is formed. It is also preferable that the coil device 10 form such a plate-shaped portion inter-wire space 86 for the same reason as that for forming the inner first inter-wire space.

As described above, in the coil device 10 illustrated in FIGS. 1 to 3, the inter-wire spaces 81a to 81v and 82a to 82c formed in the winding portion 42 include the first inter-wire spaces 81a to 81v not including the magnetic material and the second inter-wire spaces 82a to 82c including the magnetic material. In such a coil device 10, the second inter-wire spaces 82a to 82c improve the inductor, and the presence of the first inter-wire spaces 81a to 81v can prevent a problem that dielectric breakdown occurs between wire cross sections.

Note that the present disclosure is not limited to the above-described embodiments, and various modifications can be made within the scope of the present invention.

For example, the coil device according to the present disclosure may have a first magnetic material portion 20 having a drum core shape. In the coil device, the metal wires 40 may be wound around the protrusion 24, and the winding portion 42 may have wire cross sections having different cross-sectional areas and cross-sectional shapes.

### REFERENCE SIGNS LIST

10 coil device
20 first magnetic material portion
22 plate-shaped portion
22a plate-shaped portion side surface
22b plate-shaped portion bottom surface
22c plate-shaped portion upper surface
24 protrusion
25 corner portion
30 second magnetic material portion
40 metal wire
40g winding axis
41 wire end portion
42 winding portion
43 first winding layer
44 second winding layer
45 third winding layer
46 fourth winding layer
47 fifth winding layer
51, 52, 53, 54, 55, 56, 57, 58, 59, 60, 61, 62 wire cross section
81a to 81v first inter-wire space
82a to 82c second inter-wire space
86 plate-shaped portion inter-wire space

What is claimed is:

1. A coil device comprising:
a first magnetic material portion containing a magnetic material and having a plate-shaped portion and a protrusion protruding from the plate-shaped portion;
a metal wire having a winding portion including two or more layers of winding layers wound around the protrusion; and
a second magnetic material portion containing a magnetic material and a resin, having a content ratio of the magnetic material smaller than that of the first magnetic material portion, and covering at least an outer peripheral side of the winding portion,
wherein, viewed in a predetermined cross section including a winding axis of the winding portion, in which wire cross sections of the metal wire are observed, inter-wire spaces defined by circumscribed circles circumscribing three different wire cross sections in the winding portion and having a diameter smaller than a radius of each wire cross section are formed, and
first inter-wire spaces not including a magnetic material and second inter-wire spaces including a magnetic material are included in the inter-wire spaces.

2. The coil device according to claim 1, wherein at least one of the second inter-wire spaces is an outer second inter-wire space in which at least two of the three circumscribed wire cross sections are directed to the second magnetic material portion.

3. The coil device according to claim 2, wherein at least one of the wire cross sections circumscribing the outer second inter-wire space and directed to the second magnetic material portion is further away from the plate-shaped portion as compared with the outer second inter-wire spaces.

4. The coil device according to claim 1, wherein at least one of the first inter-wire spaces is an inner first inter-wire space in which at least two of the three circumscribed wire cross sections are directed to the first magnetic material portion.

5. The coil device according to claim 1, wherein the metal wire is a round wire having a substantially circular or substantially elliptical in a cross section.

6. The coil device according to claim 1, wherein a plate-shaped portion inter-wire space defined by a circumscribed circle circumscribing two different wire cross sections of the winding portion and the plate-shaped portion, and having a diameter smaller than a radius of each of the wire cross sections, and not including a magnetic material is formed in the predetermined cross section.

7. The coil device according to claim 1, wherein a mean particle diameter of the magnetic material included in the second inter-wire spaces is smaller than a mean particle diameter of the magnetic material included in the second magnetic material portion.

8. The coil device according to claim 1, wherein an average distance from a corner portion formed between the plate-shaped portion and the protrusion to the second inter-wire spaces included in the predetermined cross section is longer than an average distance from the corner portion to the first inter-wire spaces included in the predetermined cross section.

9. The coil device according to claim 1, wherein the content ratio of the magnetic material in the second magnetic material portion is 50% or more.
